(19) United States
(12) Patent Application Publication
(10) Pub. No.: US 2013/0110994 A1
(43) Pub. Date: May 2, 2013

(54) APPARATUS AND METHOD FOR RELAYING COMMUNICATION

(71) Applicant: Electronics and Telecommunications Research Int, Daejeon (KR)

(72) Inventors: Saehoon KANG, Daejeon (KR); Sunhee YANG, Daejeon (KR)

(73) Assignee: Electronics and Telecommunications Research Institute, Daejeon (KR)

(21) Appl. No.: 13/666,497

(22) Filed: Nov. 1, 2012

(30) Foreign Application Priority Data
Nov. 1, 2011 (KR) 10-2011-0113018
Sep. 17, 2012 (KR) 10-2012-0103038

(51) Int. Cl. G06F 15/177; G06F 15/16

(52) U.S. Cl. 709/220; 709/226

(57) ABSTRACT

A communication relay apparatus of a user terminal manages a network connection of the user terminal and generates a virtual terminal to replace communication of the user terminal, and when the communication relay apparatus receives a request for a network address of the user terminal from another user terminal, the communication relay apparatus provides a network address of a virtual terminal to replace communication of the user terminal.

### CROSS-REFERENCE TO RELATED APPLICATION

This application claims priority to and the benefit of Korean Patent Application No. 10-2011-0113018 and 10-2012-0103038 filed in the Korean Intellectual Property Office on Nov. 1, 2011 and Sep. 17, 2012, the entire contents of which are incorporated herein by reference.

### BACKGROUND OF THE INVENTION

(a) Field of the Invention

The present invention relates to a method and apparatus for relaying communication. More particularly, the present invention relates to a method and apparatus for relaying communication between user terminals using network virtualization.

(b) Description of the Related Art

Due to an intrinsic limitation that is designed for only a relatively small number of fixed hosts, an existing IP network has many problems, particularly, many problems that should be solved, such as mobility support of a terminal, or multi-homing that supports a connection to a plurality of networks, and separation of an identifier of a terminal and a location identifier necessary for routing (ID/location separation).

However, because apparatuses constituting an existing network system are in a very closed state, it is very difficult to apply a new network structure or protocol thereto, and this has been a main obstacle to remarkable innovation of a network.

Nowadays, as a means for solving such a problem, network virtualization technology has been in the spotlight. Network virtualization is technology that running a plurality of independent virtual networks on the shared physical infrastructure by abstracting a physical infrastructure of a network. When network virtualization technology is used, an existing IP-based network and a plurality of virtual networks having a separate characteristic may be independently operated.

When a concept of virtualization with reference to FIG. 1 is described, a virtual network 10, which is a content-centric network, and a virtual network 20, which is a delay tolerant network, may independently operate while sharing the same physical infrastructure 40 with help of a virtualization layer 30.

In this way, a virtual network may be formed in a connection form of several kinds of virtual nodes according to a purpose, and a virtual node may provide a function of a server or storage for a specific service as well as having a switch or router function for transmission of an existing simple packet. Further, on the virtual network, a necessary virtual node may be dynamically generated or deleted, and a physical resource location of the virtual node may be dynamically changed.

### SUMMARY OF THE INVENTION

The present invention has been made in an effort to provide a method and apparatus for relaying communication having advantages of effectively solving network mobility, multi-homing, and ID/Location separation of a terminal in which the existing IP network has difficulty in supporting.

An exemplary embodiment of the present invention provides a communication relay apparatus of a user terminal. The communication relay apparatus includes a connection management unit and a resource management unit. The connection management unit manages a network connection of the user terminal, and determines whether a virtual terminal to replace communication of the user terminal is generated. The resource management unit generates the virtual terminal, and when generation of the virtual terminal is determined, allocates the same identifier as that of the user terminal to the virtual terminal, and allocates a network address different from that of the user terminal.

The resource management unit may map and manage a network address of the virtual terminal of the user terminal, and when the resource management unit receives a request for a network address of the user terminal from another user terminal, the resource management unit may transfer a network address of the virtual terminal to the other user terminal.

The connection management unit may allocate a network address of a network to which the user terminal is connected, and the virtual terminal may communicate with the user terminal using the network address of the user terminal, and the user terminal may communicate with the virtual terminal using a network address of the virtual terminal.

The virtual terminal may register the network address of the user terminal.

The connection management unit may transmit a network connection acceptance message to the user terminal to correspond to a network connection request from the user terminal, and the network connection acceptance message may include a network address of the user terminal and a network address of the virtual terminal.

The connection management unit may determine whether the virtual terminal has migrated when the virtual terminal has been already generated, and the resource management unit may migrate the virtual terminal based on a location of the user terminal.

The virtual terminal may transfer the packet to a network address of the user terminal when the virtual terminal receives a packet of the user terminal from the other user terminal.

The virtual terminal may determine an identifier of a reception side user terminal from the packet and transmit the packet to a network address corresponding to the identifier of the reception side user terminal, when the virtual terminal receives a packet that sets a network address of the virtual terminal from the user terminal as a destination.

Another embodiment of the present invention provides a method of relaying communication of a user terminal in a communication relay apparatus. The method includes: generating a virtual terminal to replace communication of the user terminal; allocating an identifier and a network address to the virtual terminal; and transmitting, when a request for a network address of the user terminal is received from another user terminal, the network address of the virtual terminal to the other user terminal.

The allocating of an identifier may include allocating the same identifier as that of the user terminal as an identifier of the virtual terminal, and allocating a network address different from that of the user terminal as a network address of the virtual terminal.

The generating of a virtual terminal may include: receiving a request for a network connection from the user terminal; allocating a network address of the user terminal; generating, if a virtual terminal to replace communication of the user terminal is not generated, the virtual terminal; and transmitting a network address of the virtual terminal and a network address of the user terminal to the user terminal.

The method may further include migrating, if a virtual terminal to replace communication of the virtual terminal is generated, the virtual terminal based on a location of the user terminal.

### BRIEF DESCRIPTION OF THE DRAWINGS

FIG. 1 is a diagram illustrating a general virtualization concept.

FIG. 2 is a block diagram illustrating a configuration of a network system according to an exemplary embodiment of the present invention.

FIG. 3 is a flowchart illustrating a method of generating a virtual terminal in a communication relay apparatus that is shown in FIG. 2.

FIG. 4 is a flowchart illustrating a method of migrating a virtual terminal in a communication relay apparatus that is shown in FIG. 2.

FIG. 5 is a flowchart illustrating an example of a method of performing communication relay with a communication relay apparatus that is shown in FIG. 2.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

In this specification, a user terminal may indicate a mobile station (MS), a mobile terminal (MT), a subscriber station (SS), a portable subscriber station (PSS), user equipment (UE), and an access terminal (AT) and may include an entire function or a partial function of the MT, the SS, the PSS, the UE, and the AT.

In this specification, a communication relay apparatus may indicate a base station (BS), an access point (AP), a radio access station (RAS), a node B, an evolved node B (eNodeB), a base transceiver station (BTS), a mobile multihop relay (MMR)-BS, and a relay and may include an entire function or a partial function of the AP, the RAS, the node B, the eNodeB, the BTS, the MMR-BS, and the relay.

Hereinafter, an apparatus and method for relaying communication according to an exemplary embodiment of the present invention will be described in detail with reference to the drawings.

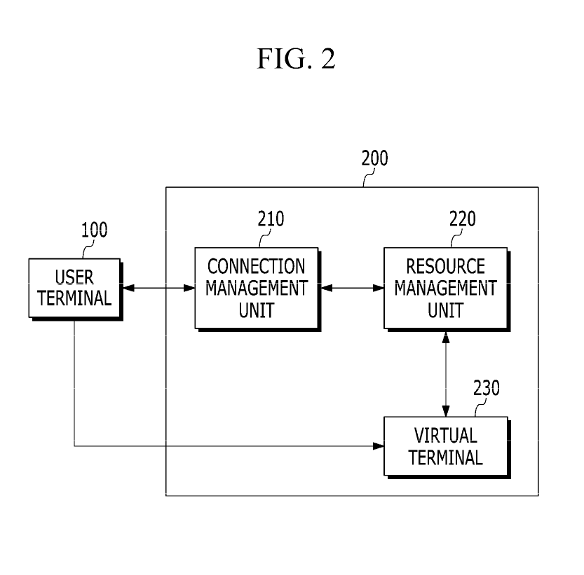

FIG. 2 is a block diagram illustrating a configuration of a network system according to an exemplary embodiment of the present invention.

Referring to FIG. 2, the network system includes a user terminal 100 and a communication relay apparatus 200.

The user terminal 100 transmits/receives a packet and is positioned at a start point or an end point of a packet transfer path. An intrinsic identifier is allocated to the user terminal 100, and a network address in which a connected network manages is provided to the user terminal 100.

The communication relay apparatus 200 manages a network connection and a network resource of the user terminal 100 and relays communication of the user terminal 100 using virtualization technology. The communication relay apparatus 200 includes a connection management unit 210, a resource management unit 220, and a virtual terminal 230.

The connection management unit 210 manages a network connection of the user terminal 100, and the resource management unit 220 manages a resource within a network. Particularly, the resource management unit 220 generates the virtual terminal 230 corresponding to the user terminal 100. That is, the virtual terminal 230 is generated by the resource management unit 220 and performs a function of the user terminal 100 in a network. The same identifier as that of the corresponding user terminal 100 is allocated to the virtual terminal 230. For example, when it is assumed that a user terminal A and a virtual terminal A′ corresponding thereto are generated, the user terminal A may communicate with other user terminals through the virtual terminal A′, and other user terminals wanting to communicate with the user terminal A may communicate with the user terminal A by sending a packet to the virtual terminal A′ corresponding to the user terminal A. In this case, the virtual terminal A′ transfers all packets advancing toward the user terminal A to the user terminal A, and when a connection to the user terminal A is dropped, the virtual terminal A′ buffers the packets, and when a connection to the user terminal A is restored, the virtual terminal A′ transfers the packets having been buffered to the user terminal A.

When the connection management unit 210 receives a request for a network connection from the user terminal 100, the connection management unit 210 determines whether the corresponding user terminal 100 can be connected, and if corresponding user terminal 100 can be connected, the connection management unit 210 selects one of network addresses in which a corresponding domain manages and allocates the selected one to the user terminal 100. Further, the connection management unit 210 determines whether the virtual terminal 230 corresponding to the user terminal 100 has been generated, and if the virtual terminal 230 corresponding to the user terminal 100 has been generated, the connection management unit 210 determines a location of the virtual terminal 230 and determines whether the virtual terminal 230 has migrated.

When the connection management unit 210 determines generation of the virtual terminal 230, the connection management unit 210 requests generation of a virtual terminal to the resource management unit 220.

The resource management unit 220 generates the virtual terminal 230 corresponding to the user terminal 100 at an appropriate location. When the virtual terminal 230 corresponding to the user terminal 100 is generated, the resource management unit 220 migrates the virtual terminal 230 to a location that can provide an optimal communication environment with the user terminal 100. For example, when the user terminal A having connected to a network domain A moves to a network domain B and is connected thereto, the resource management unit 220 migrates the virtual terminal A′ corresponding to the user terminal A to the network domain B.

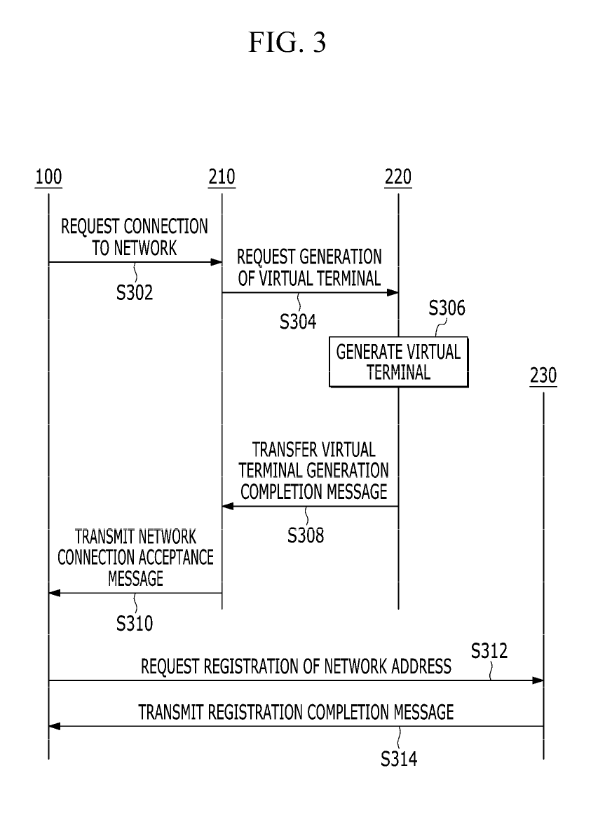

FIG. 3 is a flowchart illustrating a method of generating a virtual terminal in a communication relay apparatus that is shown in FIG. 2.

Referring to FIG. 3, when the user terminal 100 requests a connection to a specific network domain (S302), the connection management unit 210 that manages a corresponding network domain determines whether to accept a connection to the network and whether a virtual terminal is generated or whether migration is performed, and performs a necessary operation.

If the virtual terminal 230 corresponding to the user terminal 100 having requested the connection does not exist, the connection management unit 210, having received the request for a connection to the network from the user terminal 100 determines generation of the virtual terminal 230 corresponding to the user terminal 100.

When generation of the virtual terminal 230 is determined, the connection management unit 210 requests generation of the virtual terminal 230 to the resource management unit 220 (S304).

The resource management unit 220 generates the virtual terminal 230 at an optimal location in consideration of approach of the user terminal 100 to a network and use of a network resource (S306).

The resource management unit 220 allocates the same identifier as that of the user terminal 100 to the virtual terminal 230 and allocates a separate network address. The resource management unit 220 maps and manages an identifier of the virtual terminal 230 and an allocated network address of the virtual terminal 230.

The resource management unit 220 transfers a virtual terminal generation completion message including network address information of the virtual terminal 230 to the connection management unit 210 (S308).

When the connection management unit 210 receives a virtual terminal generation completion message from the resource management unit 220, the connection management unit 210 allocates one of network addresses that a corresponding domain manages to a network address that the user terminal 100 is to use, and transmits a network connection acceptance message including a network address that is allocated to the virtual terminal 230 and a network address that is allocated to the user terminal 100 to the user terminal 100 (S310).

The user terminal 100, having received the network connection acceptance message from the connection management unit 210 connects to the virtual terminal 230 using a network address of the virtual terminal 230 that is included within the network connection acceptance message, and the user terminal 100 requests a registration of the network address of the user terminal 100 to the virtual terminal 230 (S312).

The virtual terminal 230 authenticates a virtual terminal through an appropriate authentication method of a registration request of a network address from the user terminal 100, and when an authentication process has succeeded, the virtual terminal 230 registers a network address of the user terminal 100 to correspond to an identifier of the user terminal 100 and transmits a registration completion message to the user terminal 100 (S314). In this case, it is unnecessary for a registered network address of the user terminal 100 to be one, and when the user terminal 100 is connected to a plurality of networks, several network addresses may be registered. Further, as an authentication method, for example, an identifier/password combination or a certificate of authentication may be used.

The virtual terminal 230 communicates with the user terminal 100 using one of registered several network addresses of the user terminal 100, and may determine a network address to communicate according to a separate priority determination method.

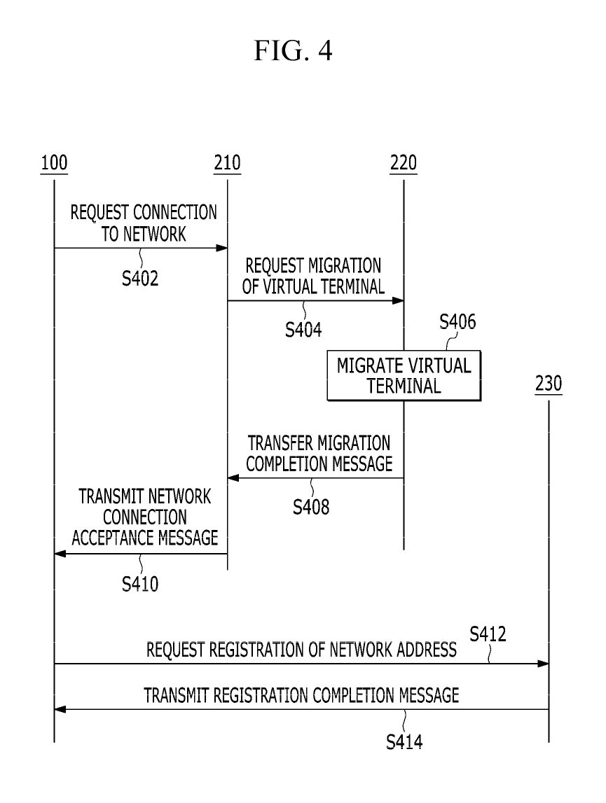

FIG. 4 is a flowchart illustrating a method of migrating a virtual terminal in a communication relay apparatus that is shown in FIG. 2.

Referring to FIG. 4, when the user terminal 100 requests a connection to a specific network domain (S402), the connection management unit 210 that manages a corresponding network domain determines whether to accept a connection to a network and whether a virtual terminal has been generated or whether migration has been performed, and performs a necessary operation.

The virtual terminal 230 has been already generated, but when it is determined that migration of the virtual terminal 230 is necessary, the connection management unit 210, having received a request for a connection to a network from the user terminal 100 requests migration of the virtual terminal 230 to the resource management unit 220 (S404).

The resource management unit 220 migrates the virtual terminal 230 to an optimal location based on a location of the user terminal 100 (S406).

Next, the resource management unit 220 transfers a migration completion message of the virtual terminal 230 to the connection management unit 210 (S408).

When the connection management unit 210 receives the migration completion message from the resource management unit 220, the connection management unit 210 allocates a network address that the user terminal 100 is to use, as described with reference to FIG. 3, and the connection management unit 210 transmits a network connection acceptance message including network address information that is allocated to the virtual terminal 230 and a network address that is allocated to the user terminal 100 to the user terminal 100 (S410).

Similar to a description that is given with reference to FIG. 3, in the following process, the user terminal 100 connects to the virtual terminal 230 using a network address of the virtual terminal 230 and requests registration of a network address thereof to the virtual terminal 230 (S412), and the virtual terminal 230 registers a network address of the user terminal 100 corresponding thereto and transmits a registration completion message to the user terminal 100 (S414).

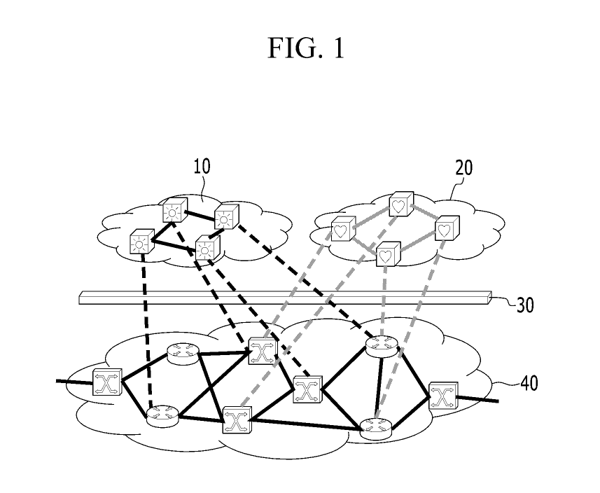

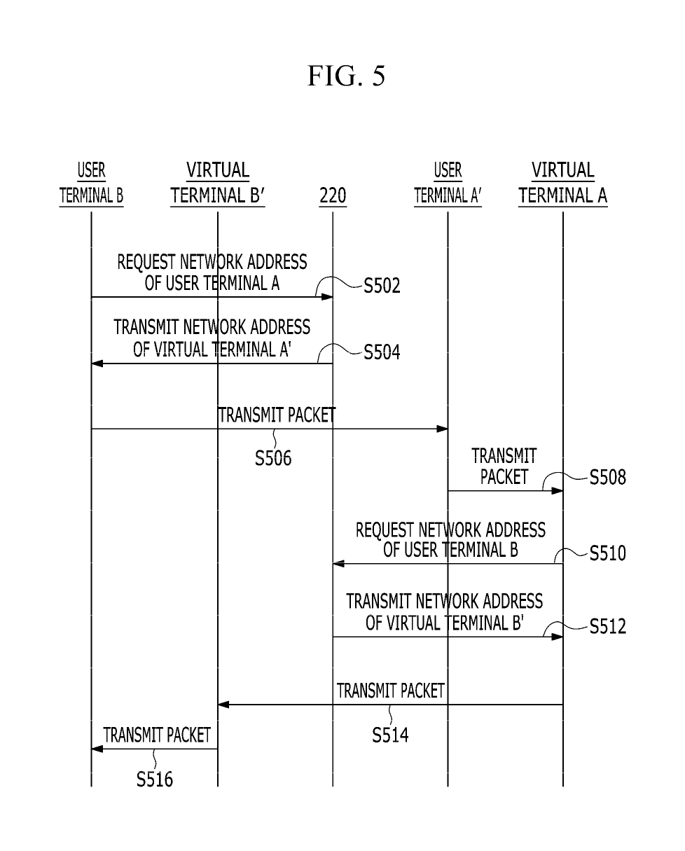

FIG. 5 is a flowchart illustrating an example of a method of performing communication relay with a communication relay apparatus that is shown in FIG. 1.

Referring to FIG. 5, a user terminal B wanting to communicate with a user terminal A requests a network address of the user terminal A to the resource management unit 220 (S502). In this case, the network address request includes an identifier of the user terminal A.

The resource management unit 220 searches for a network address of a virtual terminal A′ that is mapped to the identifier of the user terminal A that is included in the network address request, and transmits the network address of the virtual terminal A′ to the user terminal B (S504).

The user terminal B generates a packet using the identifier of the user terminal A and transmits the packet using the network address of the virtual terminal A′ (S506).

When the virtual terminal A′ receives the packet from the user terminal B, the virtual terminal A′ determines an identifier of the user terminal A from the received packet, and transmits the packet to the user terminal A using the registered network address of the user terminal A (S508).

Similarly, the user terminal A wanting to communicate with the user terminal B requests a network address of the user terminal B to the resource management unit 220 (S510). In this case, the network address request includes an identifier of the user terminal B.

The resource management unit 220 searches for a network address of a virtual terminal B′ that is mapped to an identifier of the user terminal B that is included in the network address request, and transmits the network address of the virtual terminal B′ to the user terminal A (S512).

The user terminal A generates a packet using the identifier of the user terminal B and transmits the packet using the network address of the virtual terminal B′ (S514).

When the virtual terminal B′ receives the packet from the user terminal A, the virtual terminal B′ determines the identifier of the user terminal B from the received packet, and transmits the packet to the user terminal B using the registered network address of the user terminal B (S516).

In FIG. 5, a case in which the user terminals A and B receive a packet using corresponding virtual terminals A′ and B′ has been described. The virtual terminal is not related to only reception of a packet, and in some cases, the user terminal may transmit a packet through a virtual terminal thereof.

For example, when the user terminal 100 wishes to transmit a packet to a receiving side user terminal, the receiving side user terminal may not be connected to a network. In this case, when a virtual terminal corresponding to the receiving side user terminal has already been generated in the network, the virtual terminal may receive a packet instead of the receiving side user terminal, but when a virtual terminal corresponding to the receiving side user terminal is not generated, communication cannot be performed. When a virtual terminal corresponding to the receiving side user terminal is not generated, the user terminal 100 generates a packet to send to the receiving side using an identifier of the receiving side user terminal instead of a network address of the receiving side user terminal, again encapsulates the network address of the virtual terminal 230 to a destination address, and transmits the packet to the virtual terminal 230. The virtual terminal 230, having received the packet finds out an identifier of the receiving side user terminal by decapsulating the received packet, searches for a network address corresponding thereto in the resource management unit 220, and attempts packet transmission until communication can be performed. When the virtual terminal 230 cannot find the receiving side user terminal in the network after a predetermined time, the virtual terminal 230 drops a buffered packet and notifies the user terminal that packet transmission failed.

According to an exemplary embodiment of the present invention, by generating a virtual terminal to replace a communication function of a user terminal within a network and by enabling the virtual terminal to relay communication between terminals, a problem of a mobility support of an existing IP, separation of an identifier/location identifier, and multi-homing can be effectively solved. Particularly, according to an exemplary embodiment of the present invention, a network address change and a network drop problem that may occur according to movement of a mobile terminal in a mobile environment can be effectively coped with, and when compared with mobile IP, which is an existing method for solving a related problem, an inefficiency problem of triangular routing can be effectively overcome through migration of a virtual terminal.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication relay apparatus of a user terminal, the communication relay apparatus comprising:
a connection management unit that manages a network connection of the user terminal and that determines whether a virtual terminal to replace communication of the user terminal is generated; and
a resource management unit that generates the virtual terminal when generation of the virtual terminal is determined, and that allocates the same identifier as that of the user terminal to the virtual terminal and that allocates a network address different from that of the user terminal.

2. The communication relay apparatus of claim 1, wherein the resource management unit maps and manages a network address of the virtual terminal of the user terminal, and
the resource management unit transfers a network address of the virtual terminal to another user terminal, when the resource management unit receives a request for a network address of the user terminal from the other user terminal.

3. The communication relay apparatus of claim 1, wherein the connection management unit allocates a network address of a network to which the user terminal is connected, and
the virtual terminal communicates with the user terminal using the network address of the user terminal, and the user terminal communicates with the virtual terminal using a network address of the virtual terminal.

4. The communication relay apparatus of claim 3, wherein the virtual terminal registers the network address of the user terminal.

5. The communication relay apparatus of claim 3, wherein the connection management unit transmits a network connection acceptance message to the user terminal to correspond to a network connection request from the user terminal, and
the network connection acceptance message comprises a network address of the user terminal and a network address of the virtual terminal.

6. The communication relay apparatus of claim 1, wherein the connection management unit determines whether the virtual terminal has migrated, when the virtual terminal has been already generated, and
the resource management unit migrates the virtual terminal based on a location of the user terminal.

7. The communication relay apparatus of claim 2, wherein the virtual terminal transfers the packet to a network address of the user terminal when the virtual terminal receives a packet of the user terminal from the other user terminal.

8. The communication relay apparatus of claim 2, wherein the virtual terminal determines an identifier of a reception side user terminal from the packet and transmits the packet to a network address corresponding to the identifier of the reception side user terminal, when the virtual terminal receives a packet that sets a network address of the virtual terminal from the user terminal as a destination.

9. A method of relaying communication of a user terminal in a communication relay apparatus, the method comprising:
generating a virtual terminal to replace communication of the user terminal;
allocating an identifier and a network address to the virtual terminal; and
transmitting, when a request for a network address of the user terminal is received from another user terminal, the network address of the virtual terminal to the other user terminal.

10. The method of claim 9, wherein the allocating of an identifier comprises:
allocating the same identifier as that of the user terminal as an identifier of the virtual terminal; and
allocating a network address different from that of the user terminal as a network address of the virtual terminal.

11. The method of claim 9, wherein the generating of a virtual terminal comprises:
receiving a request for a network connection from the user terminal;
allocating a network address of the user terminal;
generating, if a virtual terminal to replace communication of the user terminal is not generated, the virtual terminal; and
transmitting a network address of the virtual terminal and a network address of the user terminal to the user terminal.

12. The method of claim 9, further comprising migrating, if a virtual terminal to replace communication of the virtual terminal is generated, the virtual terminal based on a location of the user terminal.

13. The method of claim 9, wherein the allocating of an identifier comprises mapping and storing an identifier of the virtual terminal and a network address of the virtual terminal, and
the transmitting of a network address comprises searching for a network address of the virtual terminal that is mapped to an identifier of the user terminal that is included in the request for the network address.

14. The method of claim 9, further comprising:
determining, when a packet that sets a network address of the virtual terminal as a destination is received from the user terminal, an identifier of a reception side user terminal from the packet; and
transmitting the packet to a network address corresponding to the identifier of the reception side user terminal.

15. The method of claim 9, further comprising transferring, when a packet of the user terminal is received from the other user terminal, the packet to the network address of the user terminal.
